(19) United States
(12) Patent Application Publication
(10) Pub. No.: US 2023/0219517 A1
(43) Pub. Date: Jul. 13, 2023

(54) PNEUMATIC SEAT SAFETY SYSTEM OF VEHICLE, CONTROL METHOD, AND COMPUTER READABLE MEDIUM

(71) Applicant: ZF Automotive Technologies (Shanghai) Co., Ltd, Shanghai (CN)

(72) Inventors: Yuanyi CHENG, Shanghai (CN); Fengzhan WU, Shanghai (CN); Ruichi CHEN, Shanghai (CN)

(21) Appl. No.: 18/015,764

(22) PCT Filed: Jul. 13, 2021
(86) PCT No.: PCT/CN2021/105903

§ 371 Date: Jan. 12, 2023

(30) Foreign Application Priority Data
Jul. 15, 2020 (CN) 202010680192.0

(51) Int. Cl. B60R 21/207; B60R 21/0132; B60R 21/015; B60R 21/231; B60N 2/90; B60N 2/66

(52) U.S. Cl. CPC B60R 21/207; B60R 21/0132; B60R 21/01516; B60R 21/23138; B60N 2/976; B60N 2/665; B60R 2021/2074; B60R 2021/01013

(57) ABSTRACT

A safety system and control method for a pneumatic seat of a vehicle, and a computer-readable medium, the pneumatic seat (10) including a plurality of airbags (101, 102, 103, 104, 105, and 106) corresponding to body parts of an occupant, an information collection module, an information integration module (3), and a control module (4), where the information collection module is configured to collect vehicle body data, motion information, and external environment information of the vehicle, the information integration module (3) is configured to determine a current working scenario of the vehicle based on the vehicle body data, the motion information, and the external environment information; and the control module (4) is configured to inflate a seat cushion airbag (105) when it is determined that the current working scenario is a first working scenario, so as to partially deploy the seat cushion airbag (105); and is configured to fully inflate and deploy the seat cushion airbag (105) when it is determined that the current working scenario is a second working scenario.

### TECHNICAL FIELD

The present invention relates to a safety system, a control method, and a medium, and in particular, to a safety system configured with a plurality of airbags, a control method, and a computer-readable medium.

### BACKGROUND ART

With the development of the automobile industry, in addition to people's requirements for safety, the requirements for vehicle comfort are also increasing. People are not only satisfied with position adjustment of vehicle seats, but expect the vehicle seats to provide an occupant with more comfortable ride experience. There are already some pneumatic seats installed with airbags or gas bags on the market, that is, airbags or gas bags are disposed at positions corresponding to the head, the shoulders, the waist and back of an occupant and a seat cushion in a vehicle seat, and the occupant may adjust inflation and deflation of the airbags or gas bags according to requirements of the occupant, so as to obtain the most comfortable ride mode.

However, the existing pneumatic seats basically focus on the comfort design, and there is no cooperative relationship between the airbags, but work independently, and mainly rely on the operations of the occupant to adjust the inflation amount.

### SUMMARY OF THE INVENTION

To resolve the defects in the prior art that airbags or gas bags of pneumatic seats are mainly used to adjust the ride comfort and most of them cannot provide safety protection for occupants, the present invention provides a safety system and the corresponding control method for a pneumatic seat of a vehicle that ensure the safety of an occupant by utilizing airbags or gas bags, and can adjust a sitting posture of the occupant especially in an intense driving process or when it is predicted that a collision may occur, and a computer-readable medium.

The object of the present invention is realized by the following technical solutions:

A safety system for a pneumatic seat of a vehicle, the pneumatic seat including at least one headrest airbag, a shoulder support airbag, at least one side airbag, at least one lumbar support airbag, at least one seat cushion airbag, and at least one leg support airbag, where the safety system for a pneumatic seat further includes an information collection module, an information integration module, and a control module, where the information collection module is configured to collect vehicle body data, motion information, and external environment information of the vehicle;

the information integration module is configured to determine a current working scenario of the vehicle based on the vehicle body data, the motion information, and the external environment information that are collected by the information collection module, where the information integration module may be an integrated safety domain (ISD) electronic control unit (ECU) (ISDU); and
the control module is configured to inflate the seat cushion airbag based on the current working scenario determined by the information integration module and when it is determined that the current working scenario is a first working scenario, so as to partially deploy the seat cushion airbag; and is configured to fully inflate and deploy the seat cushion airbag when it is determined that the current working scenario is a second working scenario. The first working scenario is an intense driving environment, for example, an environment with a higher vehicle velocity, a bumpy road, a rapid acceleration, a rapid deceleration, etc. To increase the comfort of the occupant, the seat cushion airbag is partially deployed to partially lift the thighs. The second working scenario is a scenario where it is predicted that an unavoidable collision is about to occur. In this case, the seat cushion airbag is fully inflated, and the sitting posture of the occupant is adjusted before the collision, to prevent the occupant from submarining.

Preferably, the control module is further configured to inflate the side airbag and the leg support airbag when it is determined that the current working scenario is the first working scenario.

Preferably, the control module is further configured to: when it is determined that the current working scenario is the second working scenario and before or when the seat cushion airbag is fully inflated and deployed, inflate and deflate the lumbar support airbag at a first air pressure to make the lumbar support airbag vibrate to prompt the occupant.

Preferably, the control module is further configured to fully inflate and deploy one or more of the headrest airbag, the side airbag, and the leg support airbag when it is determined that the current working scenario is the second working scenario, so as to provide the occupant with wraparound protection.

Preferably, the control module is further configured to fully inflate and deploy a side airbag close to a predicted collision side when it is determined that the current working scenario is the second working scenario.

Preferably, the control module is configured to control inflation and deflation of the seat cushion airbag based on a size and a weight of an occupant when it is determined that the current working scenario is a third working scenario.

Preferably, the control module is configured to inflate and deflate the lumbar support airbag at a second air pressure when it is determined that the current working scenario is a third working scenario, so as to implement a massage function.

Preferably, the information collection module is configured to collect external information provided by the Internet of vehicles and/or in-vehicle information provided by an in-vehicle monitoring system; and

the information integration module is further configured to determine the current working scenario of the vehicle based on the external information provided by the Internet of vehicles and/or the in-vehicle information provided by the in-vehicle monitoring system that are collected by the information collection module and based on the vehicle body data, the motion information, and the external environment information.

Preferably, the information collection module includes: a vehicle sensor unit, an advanced driving assistance system (ADAS), and an active safety system, where

the vehicle sensor unit includes: a velocity sensor, an acceleration sensor, a collision sensor, and a steering wheel angle sensor;
the active safety system includes electronic power steering (EPS) system, an antilock brake system (ABS), an electronic stability program (ESP) system, and an autonomous emergency braking (AEB) system; and
the in-vehicle monitoring system includes a 2D camera, a 3D camera, an internal radar, and a driver status monitoring unit.

Preferably, the control module is configured to inflate, based on the motion information, at least one of the following airbags that are on a side opposite to a moving direction of the vehicle: the shoulder support airbag, the side airbag, the lumbar support airbag, the seat cushion airbag, and the leg support airbag.

Preferably, the safety system for a pneumatic seat further includes an identification module configured to identify internal pressures of the side airbag, the lumbar support airbag, and the seat cushion airbag, and generate an out-of-position signal based on the internal pressures; and

the control module is further configured to inflate and deflate one or more of the leg support airbag, the seat cushion airbag, and the lumbar support airbag at a third air pressure based on the out-of-position signal provided by the identification module, to generate vibration.

Preferably, the control module is configured to control inflation and deflation of one or more of the headrest airbag, the shoulder support airbag, the side airbag, the lumbar support airbag, the leg support airbag, and the seat cushion airbag when it is determined that the current working scenario is the first working scenario, to move the body of an occupant to be adapted to a motion status of the vehicle and/or a change of the motion status of the vehicle.

The present invention further discloses a control method for a pneumatic seat of a vehicle, the pneumatic seat including a headrest airbag, a shoulder support airbag, a side airbag, a lumbar support airbag, a seat cushion airbag, and a leg support airbag, where the control method includes:

S1: collecting vehicle body data, motion information, and external environment information of the vehicle;
S2: determining a current working scenario of the vehicle based on the vehicle body data, the motion information, and the external environment information;
S3: determining the current working scenario, and if the current working scenario is a first working scenario, proceeding to step S4; or if the current working scenario is a second working scenario, proceeding to step S5;
S4: inflating the seat cushion airbag to partially deploy the seat cushion airbag, and then proceeding to step S6;
S5: fully inflating and deploying the seat cushion airbag, and then ending the process;
S6: determining whether the current working scenario is changed, and if yes, returning to step S3; or if no, ending the process.

Preferably, step S4 further includes: inflating the side airbag and the leg support airbag.

Preferably, step S5 further includes: before or when the seat cushion airbag is fully inflated and deployed, inflating and deflating the lumbar support airbag at a first air pressure to make the lumbar support airbag vibrate.

Preferably, step S5 further includes: fully inflating and deploying one or more of the headrest airbag, the side airbag, and the leg support airbag, so as to implement wraparound protection for the occupant.

Preferably, step S5 further includes: fully inflating and deploying a side airbag close to a predicted collision side.

Preferably, step S3 further includes: determining the current working scenario, and if the current working scenario is a third working scenario, for example, in smooth driving, proceeding to step S7; and

S7: controlling inflation and deflation of the seat cushion airbag based on a size and a weight of an occupant.

Preferably, step S7 further includes: inflating and deflating the lumbar support airbag at a second air pressure.

Preferably, step S7 further includes: identifying internal pressures of the side airbag, the lumbar support airbag, and the seat cushion airbag, generating an out-of-position signal based on the internal pressures, and inflating and deflating one or more of the leg support airbag, the seat cushion airbag, and the lumbar support airbag at a third air pressure based on the out-of-position signal, to generate vibration.

Preferably, step S1 further includes: collecting external information provided by the Internet of vehicles and/or in-vehicle information provided by an in-vehicle monitoring system; and

step S2 further includes: determining the current working scenario of the vehicle based on the external information provided by the Internet of vehicles and/or the in-vehicle information provided by the in-vehicle monitoring system and based on the vehicle body data, the motion information, and the external environment information.

Preferably, the motion information includes a velocity, an acceleration, steering information, and information from ESP, an ABS, an ESP, and AEB;

the external environment information is information from an ADAS of the vehicle.

Preferably, step S4 further includes: inflating, based on the motion information, at least one of the following airbags that are on a side opposite to a moving direction of the vehicle: the shoulder support airbag, the side airbag, the lumbar support airbag, the seat cushion airbag, and the leg support airbag.

Preferably, step S4 further includes: controlling inflation and deflation of one or more of the headrest airbag, the shoulder support airbag, the side airbag, the lumbar support airbag, the leg support airbag, and the seat cushion airbag, to move the body of an occupant to be adapted to a motion status of the vehicle and/or a change of the motion status of the vehicle.

The present invention further provides a computer-readable medium, where the computer-readable medium stores computer instructions that, when executed by a processor, implement the steps of the control method for a pneumatic seat of any one of the above.

The technical effects obtained by the present invention are as follows:

1. When in the intense driving environment and it is predicted that a collision is about to occur, corresponding airbags can be inflated in time to adjust a sitting posture of the occupant, so as to ensure the safety of the occupant.

2. When it is predicted that an unavoidable collision is about to occur, the seat cushion airbag is fully inflated to prevent the occupant from submarining, and the headrest airbag, the side airbag, and the leg support airbag are inflated at the same time for assistance, so as to provide the occupant with wraparound protection.

3. In the intense driving environment, the side airbag and the leg support airbag are inflated to improve the support of the seat for the occupant, to increase the comfort of the occupant.

4. The airbags are inflated and deflated to vibrate to give the occupant various prompts, such as an out-of-position prompt, a rapid acceleration prompt, a sharp turn prompt, a collision prompt, etc., so that the occupant is well-prepared, thereby improving the driving safety.

### BRIEF DESCRIPTION OF THE DRAWINGS

FIG. 1 is a schematic diagram of arrangement of airbags in a pneumatic seat according to an embodiment of the present invention;

FIG. 2 is a structural block diagram of a safety system for a pneumatic seat according to an embodiment of the present invention;

FIG. 3 is a flowchart of a control method for a safety system for a pneumatic seat according to an embodiment of the present invention;

FIG. 4 is a flowchart of a control method for a safety system for a pneumatic seat according to another embodiment of the present invention; and

FIG. 5 is a flowchart of a control method for a safety system for a pneumatic seat according to still another embodiment of the present invention.

### DETAILED DESCRIPTION OF EMBODIMENTS

The specific implementations of the present invention will be further described below with reference to the accompanying drawings.

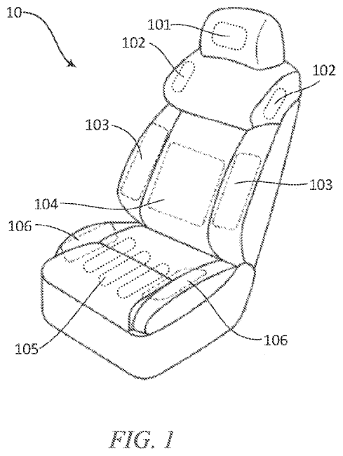

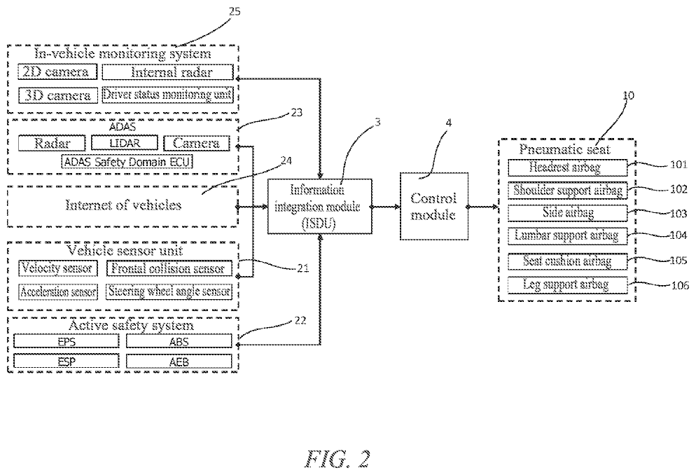

Referring to FIG. 1 to FIG. 3, a safety system for a pneumatic seat of a vehicle and a control method thereof according to an embodiment are described, the pneumatic seat 10 including at least one headrest airbag 101, a shoulder support airbag 102, at least one side airbag 103, at least one lumbar support airbag 104, at least one seat cushion airbag 105, and at least one leg support airbag 106, where each airbag may be inflated and deflated to adjust a support degree of the airbag for each body part of an occupant, and the safety system for a pneumatic seat further includes an information collection module, an information integration module 3, and a control module 4.

The information collection module is configured to collect vehicle body data, motion information, and external environment information of the vehicle. The information collection module is, for example, an ADAS 23, a vehicle sensor unit 21, and an active safety system 22. The ADAS includes a radar, a LIDAR, a camera, and an ADAS safety domain electronic control unit (ECU). The vehicle sensor unit includes a velocity sensor, a frontal collision sensor, an acceleration sensor, and a steering wheel angle sensor. The active safety system includes EPS, an ABS, an ESP, and AEB.

The information integration module 3 is configured to determine a current working scenario of the vehicle based on the vehicle body data, the motion information, for example, a vehicle velocity, an acceleration, a traveling direction, etc., and the external environment information, for example, a road condition, whether there is an obstacle near the vehicle body, etc.

The control module 4 is configured to inflate the seat cushion airbag 105 when it is determined that the current working scenario is a first working scenario, so as to partially deploy the seat cushion airbag 105; and is configured to fully inflate and deploy the seat cushion airbag 105 when it is determined that the current working scenario is a second working scenario. The first working scenario is an intense driving environment, for example, an environment with a higher vehicle velocity, a bumpy road, a rapid acceleration, a rapid deceleration, etc. In order to increase the comfort of the occupant, the seat cushion airbag is partially deployed to partially lift the thighs. The control module 4 is further configured to control inflation and deflation of one or more of the headrest airbag, the shoulder support airbag, the side airbag, the lumbar support airbag, the leg support airbag, and the seat cushion airbag when it is determined that the current working scenario is the first working scenario, to move the body of the occupant to be adapted to a motion status of the vehicle and/or a change of the motion status of the vehicle, so as to reduce discomfort caused by carsickness. The second working scenario is a scenario where it is predicted that an unavoidable collision is about to occur. In this case, the seat cushion airbag is fully inflated to prevent the occupant from submarining.

To more comprehensively know conditions of the vehicle, the occupant, and the road, the information collection module includes the Internet of vehicles 24 and an in-vehicle monitoring system 25, and the information collection module is further configured to collect external information provided through the Internet of vehicles 24 and/or in-vehicle information provided by the in-vehicle monitoring system 25. The external information provided through the Internet of vehicles may be road safety information, for example, information about a position where a traffic accident or congestion occurs. The in-vehicle detection system 25 includes a 2D camera, a 3D camera, an internal radar, and a driver status monitoring unit. The information integration module is further configured to determine the current working scenario of the vehicle based on the external information provided through the Internet of vehicles and/or the in-vehicle information provided by the in-vehicle monitoring system and based on the vehicle body data, the motion information, and the external environment information.

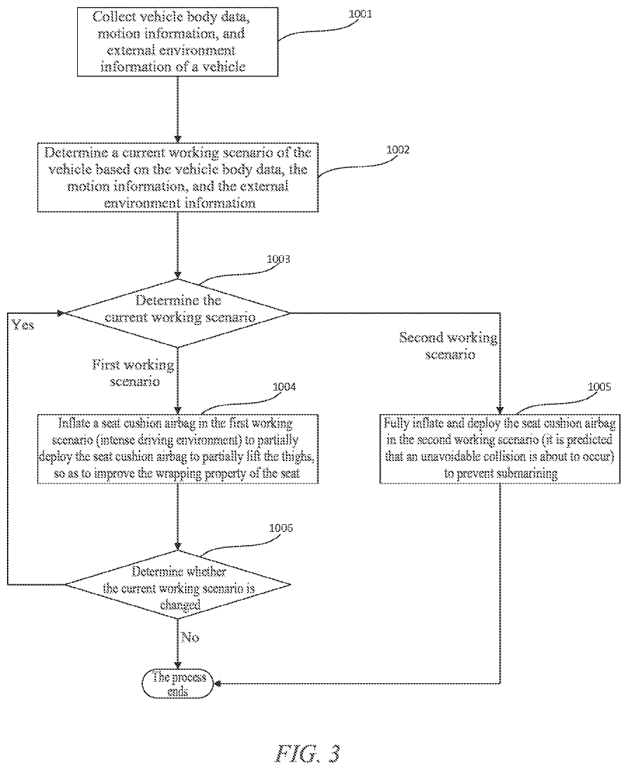

Referring to FIG. 3, the above-mentioned control method for a safety system for a pneumatic seat will be described in detail. The control method includes the following steps:

step 1001: collecting vehicle body data, motion information, and external environment information of the vehicle, where these information comes from, for example, an ADAS, a vehicle sensor unit, an active safety system, the Internet of vehicles, and an in-vehicle monitoring system;
step 1002: determining a current working scenario of the vehicle based on the vehicle body data, the motion information, and the external environment information;
step 1003: determining the current working scenario, and if the current working scenario is a first working scenario, that is, in an intense driving environment, proceeding to step 1004; or if the current working scenario is a second working scenario, that is, it is predicted that an unavoidable collision is about to occur, proceeding to step 1005;
step 1004: inflating the seat cushion airbag to partially deploy the seat cushion airbag to lift the thighs, so as to improve the wrapping property of the seat, and then proceeding to step 1006;
step 1005: fully inflating and deploying the seat cushion airbag to prevent submarining, that is, after an unavoidable collision is predicted, forcibly adjusting a sitting posture of the occupant such that the occupant is in a relatively safe posture to cope with the subsequent collision, and then ending the process;
step 1006: determining whether the current working scenario is changed, and if yes, returning to step 1003; or if no, ending the process.

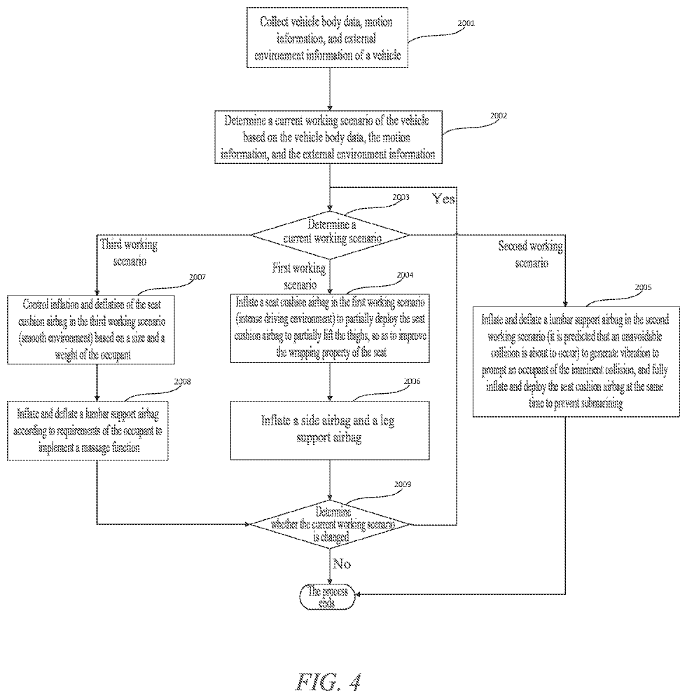

FIG. 4 illustrates a control method for a safety system for a pneumatic seat according to another embodiment of the present invention. For details about steps 2001 and 2002, reference is made to the embodiment illustrated in FIG. 3, and a difference lies in the following steps:

step 2003: determining a current working scenario, and if the scenario is a first working scenario of intense driving, proceeding to step 2004; or if the scenario is a second working scenario where an unavoidable collision is predicted, proceeding to step 2005; or if the current working scenario is a third working scenario of a smooth driving environment, proceeding to step 2007;
step 2004: inflating the seat cushion airbag to partially deploy the seat cushion airbag to partially lift the thighs, so as to improve the wrapping property of the seat;
step 2006: inflating the side airbag and the leg support airbag to further improve the support of the seat for the occupant in the intense driving environment, and then proceeding to step 2009;
step 2005: when it is predicted that an unavoidable collision is about to occur, inflating and deflating the lumbar support airbag to generate vibration to prompt the occupant of the imminent collision, fully inflating and deploying the seat cushion airbag at the same time to prevent submarining, and then ending the process;
step 2007: when the vehicle is in the third working scenario of smooth driving, controlling inflation and deflation of the seat cushion airbag based on a size and a weight of the occupant, so as to increase the comfort of the seat; and
step 2008: inflating and deflating the lumbar support airbag according to requirements of the occupant to implement a massage function, so as to further increase the comfort during smooth driving, and then proceeding to step 2009;
and determining whether the current working scenario is changed, and if yes, returning to step 2003; or if no, ending the process.

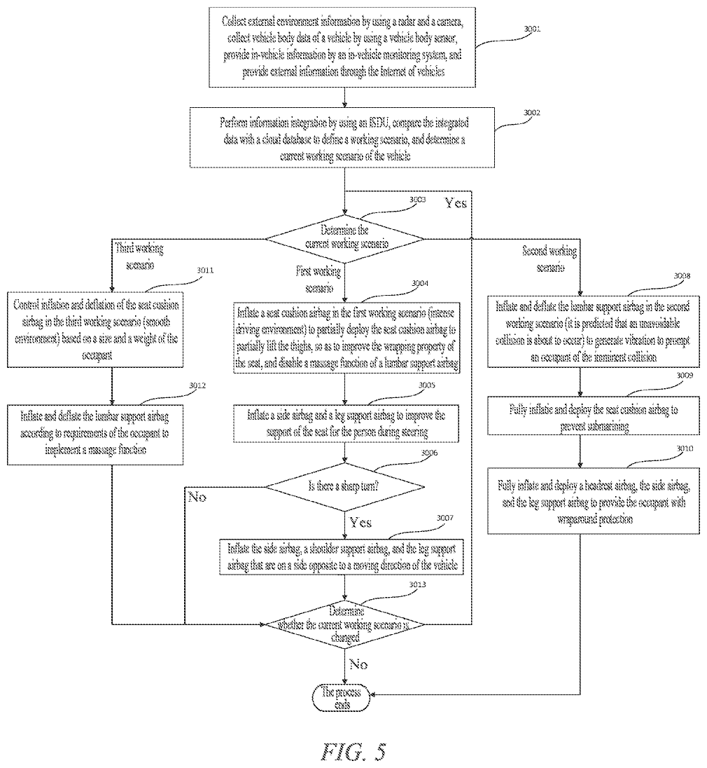

Referring to FIG. 5, a control method for a safety system for a pneumatic seat according to another embodiment is described, where the method includes the following steps:

step 3001: collecting external environment information by using a radar and a camera, collecting data of the vehicle by using a vehicle body sensor, providing in-vehicle information by an in-vehicle monitoring system, and providing external information through the Internet of vehicles;
step 3002: performing information integration by using an ISDU, comparing the integrated data with a cloud database to define a working scenario, and determining a current working scenario of the vehicle based on the integrated data;
step 3003: determining the current working scenario, and if the scenario is a first working scenario, proceeding to step 3004; or if the scenario is a second working scenario, proceeding to step 3008; or if the scenario is a third working scenario, proceeding to step 3011;
step 3004: inflating the seat cushion airbag in the first working scenario (intense driving environment) to partially deploy the seat cushion airbag to partially lift the thighs, so as to improve the wrapping property of the seat, and disabling a massage function of the lumbar support airbag;
step 3005: inflating the side airbag and the leg support airbag to improve the support of the seat for the person during steering;
step 3006: determining whether there is a sharp turn based on the data of the vehicle sensor unit; and if yes, proceeding to step 3007; or if no, proceeding to step 3013;
step 3007: inflating the side airbag, the shoulder support airbag, and the leg support airbag that are on a side opposite to a moving direction of the vehicle to increase the comfort of the occupant during the sharp turn;
step 3008: inflating and deflating the lumbar support airbag in the second working scenario (it is predicted that an unavoidable collision is about to occur) to generate vibration to prompt the occupant of the imminent collision;
step 3009: fully inflating and deploying the seat cushion airbag to prevent submarining;
step 3010: fully inflating and deploying the headrest airbag, the side airbag, and the leg support airbag to provide the occupant with wraparound protection;
step 3011: controlling inflation and deflation of the seat cushion airbag in the third working scenario (smooth environment) based on a size and a weight of the occupant, so as to make the occupant be seated comfortably;
step 3012: inflating and deflating the lumbar support airbag according to requirements of the occupant to implement a massage function; and
step 3013: determining whether the current working scenario is changed; and if yes, returning to step 3003; or if no, ending the process.

In the third working scenario of smooth driving, whether the occupant is out of position may be further identified by identifying internal pressures of the side airbag, the lumbar support airbag, and the seat cushion airbag, an out-of-position signal may be generated based on the internal pressures, and when it is found that the occupant is out of position, one or more of the leg support airbag, the seat cushion airbag, and the lumbar support airbag are inflated and deflated at a third air pressure based on the out-of-position signal, to generate vibration, so as to prompt the occupant to be seated properly in the seat, thereby preventing safety problems caused by emergencies during unsafe sitting. In the first working scenario of intense driving, to reduce the discomfort of the occupant due to carsickness, inflation and deflation of one or more of the headrest airbag, the shoulder support airbag, the side airbag, the lumbar support airbag, the leg support airbag, and the seat cushion airbag are controlled, to move the body of the occupant to be adapted to the motion status of the vehicle and/or a change of the motion status of the vehicle.

In addition, the present invention further provides a computer-readable medium, where the computer-readable medium stores computer instructions that, when executed by a processor, implement the steps of the control method for a pneumatic seat of any one of the above.

According to the present invention, the airbags disposed at positions, corresponding to the body parts of the occupant, in the pneumatic seat are utilized, and based on the specific working scenario of the vehicle, different inflation and deflation operations are performed on the airbags to protect the occupant, so as to improve the ride comfort of the occupant.

Although the specific embodiments of the present invention are described above, it should be appreciated by those skilled in the art that these are merely illustrative and that the scope of protection of the present invention is defined by the appended claims. Various changes or modifications to these embodiments may be made by those skilled in the art without departing from the principle and spirit of the present invention, and these changes or modifications fall within the scope of the present invention.

1. A safety system for a pneumatic seat of a vehicle, the pneumatic seat comprising at least one headrest airbag, a shoulder support airbag, at least one side airbag, at least one lumbar support airbag, at least one seat cushion airbag, and at least one leg support airbag, wherein the safety system for a pneumatic seat further comprises an information collection module, an information integration module, and a control module, wherein
the information collection module is configured to collect vehicle body data, motion information, and external environment information of the vehicle;
the information integration module is configured to determine a current working scenario of the vehicle based on the vehicle body data, the motion information, and the external environment information that are collected by the information collection module; and
the control module is configured to inflate the seat cushion airbag based on the current working scenario determined by the information integration module and when it is determined that the current working scenario is a first working scenario, so as to partially deploy the seat cushion airbag; and is configured to fully inflate and deploy the seat cushion airbag when it is determined that the current working scenario is a second working scenario.

2. The safety system for a pneumatic seat of claim 1, wherein the control module is further configured to inflate the side airbag and the leg support airbag when it is determined that the current working scenario is the first working scenario.

3. The safety system for a pneumatic seat of claim 1, wherein the control module is further configured to: when it is determined that the current working scenario is the second working scenario and before or when the seat cushion airbag is fully inflated and deployed, inflate and deflate the lumbar support airbag at a first air pressure to make the lumbar support airbag vibrate.

4. The safety system for a pneumatic seat of claim 3, wherein the control module is further configured to fully inflate and deploy one or more of the headrest airbag, the side airbag, and the leg support airbag when it is determined that the current working scenario is the second working scenario.

5. The safety system for a pneumatic seat of claim 3, wherein the control module is further configured to fully inflate and deploy a side airbag close to a predicted collision side when it is determined that the current working scenario is the second working scenario.

6. The safety system for a pneumatic seat of claim 1, wherein the control module is configured to control inflation and deflation of the seat cushion airbag based on a size and a weight of an occupant when it is determined that the current working scenario is a third working scenario.

7. The safety system for a pneumatic seat of claim 1, wherein the control module is configured to inflate and deflate the lumbar support airbag at a second air pressure when it is determined that the current working scenario is a third working scenario.

8. The safety system for a pneumatic seat of claim 1, wherein the information collection module is configured to collect external information provided by the Internet of vehicles and/or in-vehicle information provided by an in-vehicle monitoring system; and
the information integration module is further configured to determine the current working scenario of the vehicle based on the external information provided by the Internet of vehicles and/or the in-vehicle information provided by the in-vehicle monitoring system that are collected by the information collection module and based on the vehicle body data, the motion information, and the external environment information.

9. The safety system for a pneumatic seat of claim 8, wherein the information collection module comprises: a vehicle sensor unit, an ADAS, and an active safety system, wherein
the vehicle sensor unit comprises: a velocity sensor, an acceleration sensor, a collision sensor, and a steering wheel angle sensor;
the active safety system comprises EPS, an ABS, an ESP, and AEB; and
the in-vehicle monitoring system comprises a 2D camera, a 3D camera, an internal radar, and a driver status monitoring unit.

10. The safety system for a pneumatic seat of claim 1, wherein the control module is configured to inflate, based on the motion information, at least one of the following airbags that are on a side opposite to a moving direction of the vehicle: the shoulder support airbag, the side airbag, the lumbar support airbag, the seat cushion airbag, and the leg support airbag.

11. The safety system for a pneumatic seat of claim 1, wherein the safety system for a pneumatic seat further comprises an identification module configured to identify internal pressures of the side airbag, the lumbar support airbag, and the seat cushion airbag, and generate an out-of-position signal based on the internal pressures; and
the control module is further configured to inflate and deflate one or more of the leg support airbag, the seat cushion airbag, and the lumbar support airbag at a third air pressure based on the out-of-position signal provided by the identification module, to generate vibration.

12. The safety system for a pneumatic seat of claim 1, wherein the control module is configured to control inflation and deflation of one or more of the headrest airbag, the shoulder support airbag, the side airbag, the lumbar support airbag, the leg support airbag, and the seat cushion airbag when it is determined that the current working scenario is the first working scenario, to move the body of an occupant to be adapted to a motion status of the vehicle and/or a change of the motion status of the vehicle.

13. A control method for a pneumatic seat of a vehicle, the pneumatic seat comprising a headrest airbag, a shoulder support airbag, a side airbag, a lumbar support airbag, a seat cushion airbag, and a leg support airbag, wherein the control method comprises:
S1: collecting vehicle body data, motion information, and external environment information of the vehicle;
S2: determining a current working scenario of the vehicle based on the vehicle body data, the motion information, and the external environment information;
S3: determining the current working scenario, and if the current working scenario is a first working scenario, proceeding to step S4; or if the current working scenario is a second working scenario, proceeding to step S5;
S4: inflating the seat cushion airbag to partially deploy the seat cushion airbag, and then proceeding to step S6;
S5: fully inflating and deploying the seat cushion airbag, and then ending the process;
S6: determining whether the current working scenario is changed, and if yes, returning to step S3; or if no, ending the process.

14. The control method for a pneumatic seat of claim 13, wherein step S4 further comprises: inflating the side airbag and the leg support airbag.

15. The control method for a pneumatic seat of claim 13, wherein step S5 further comprises: before or when the seat cushion airbag is fully inflated and deployed, inflating and deflating the lumbar support airbag at a first air pressure to make the lumbar support airbag vibrate.

16. The control method for a pneumatic seat of claim 15, wherein step S5 further comprises: fully inflating and deploying one or more of the headrest airbag, the side airbag, and the leg support airbag.

17. The control method for a pneumatic seat of claim 15, wherein step S5 further comprises: fully inflating and deploying a side airbag close to a predicted collision side.

18. The control method for a pneumatic seat of claim 13, wherein step S3 further comprises: determining the current working scenario, and if the current working scenario is a third working scenario, proceeding to step S7; and
S7: controlling inflation and deflation of the seat cushion airbag based on a size and a weight of an occupant.

19. The control method for a pneumatic seat of claim 18, wherein step S7 further comprises: inflating and deflating the lumbar support airbag at a second air pressure.

20. The control method for a pneumatic seat of claim 18, wherein step S7 further comprises: identifying internal pressures of the side airbag, the lumbar support airbag, and the seat cushion airbag, generating an out-of-position signal based on the internal pressures, and inflating and deflating one or more of the leg support airbag, the seat cushion airbag, and the lumbar support airbag at a third air pressure based on the out-of-position signal, to generate vibration.

21. The control method for a pneumatic seat of claim 13, wherein step S1 further comprises: collecting external information provided by the Internet of vehicles and/or in-vehicle information provided by an in-vehicle monitoring system; and
step S2 further comprises: determining the current working scenario of the vehicle based on the external information provided by the Internet of vehicles and/or the in-vehicle information provided by the in-vehicle monitoring system and based on the vehicle body data, the motion information, and the external environment information.

22. The control method for a pneumatic seat of claim 21, wherein the motion information comprises a velocity, an acceleration, steering information, and information from ESP, an ABS, an ESP, and AEB; and
the external environment information is information from an ADAS of the vehicle.

23. The control method for a pneumatic seat of claim 13, wherein step S4 further comprises: inflating, based on the motion information, at least one of the following airbags that are on a side opposite to a moving direction of the vehicle: the shoulder support airbag, the side airbag, the lumbar support airbag, the seat cushion airbag, and the leg support airbag.

24. The control method for a pneumatic seat of claim 13, wherein step S4 further comprises: controlling inflation and deflation of one or more of the headrest airbag, the shoulder support airbag, the side airbag, the lumbar support airbag, the leg support airbag, and the seat cushion airbag, to move the body of an occupant to be adapted to a motion status of the vehicle and/or a change of the motion status of the vehicle.

25. A computer-readable medium, wherein the computer-readable medium stores computer instructions that, when executed by a processor, implement the steps of the control method for a pneumatic seat of claim 13.
